(19) United States
(12) Patent Application Publication
(10) Pub. No.: US 2016/0227394 A1
(43) Pub. Date: Aug. 4, 2016

(54) Hiding Diameter Network Topology

(71) Applicant: ALCATEL-LUCENT CANADA INC., Ottawa (CA)

(72) Inventors: Ivana Savkovic, Kanata (CN); Robert A. Mann, Carp (CN); Mike Vihtari, Kanata (CN)

(73) Assignee: ALCATEL-LUCENT CANADA INC.

(21) Appl. No.: 14/613,043

(22) Filed: Feb. 3, 2015

(51) Int. Cl. H04W 8/08

(52) U.S. Cl. CPC H04W 8/08

(57) ABSTRACT

Various exemplary embodiments relate to a network device configured to hide network topological information, the network device including: a network interface configured to communicate with other devices in a network; a memory; and a processor in communication with the network interface and the memory, the processor configured to: receive a message; identify in the message one or more Attribute Value Pairs (AVPs) with network information; define a local network identity; and evaluate a plurality of messages to determine whether one of a source of the message and a destination of the message are included in the local network identity.

### TECHNICAL FIELD

Various exemplary embodiments disclosed herein relate generally to modifying certain Diameter message headers.

### BACKGROUND

Providing roaming functionality to mobile customers involves communicating with the networks of other telecom providers. Messages in the Diameter protocol contain information that allows routing through the network or networks that the messages travel over. For example, for routing purposes Diameter messages may include the identity of Diameter devices in the source and destination networks, both the specific Origin-Host of devices as well as the realm organization of the network. The Origin-Host may also be referred to as the host_realm or Fully Qualified Domain Name (FQDN).

### SUMMARY

In light of the present need for more secure networks through topology hiding, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a network device configured to hide network topological information, the network device including: a network interface configured to communicate with other devices in a network; a memory; and a processor in communication with the network interface and the memory, the processor configured to: receive a message; identify in the message one or more Attribute Value Pairs (AVPs) with network information; define a local network identity; and evaluate a plurality of messages to determine whether one of a source of the message and a destination of the message are included in the local network identity.

Various exemplary embodiments relate to a non-transitory machine-readable storage medium encoded with instructions for execution by a Diameter Routing Agent (DRA) for hiding network topological information in a Diameter message, the medium including: instructions for receiving a Diameter message; instructions for determining a Origin-Host and a Destination-Realm based on the Diameter message; instructions for determining at least one of the Origin-Host and the Destination-Realm is external to a local network identity, and at least another one of the Origin-Host and the Destination-Realm is internal to the local network identity; instructions for removing a Route-Record AVP from the Diameter message; and instructions for suppressing additions to the Route-Record AVP.

Various exemplary embodiments relate to a non-transitory machine-readable storage medium encoded with instructions for execution by a Diameter Routing Agent (DRA) for processing a Diameter message, the medium including: instructions for identifying one or more Attribute Value Pairs (AVPs) with network information; instructions for generating one or more patterns to modify the one or more AVPs; instructions for defining a local network identity; and instructions for evaluating a plurality of messages to determine whether one of a source of the message and a destination of the message are included in the local network identity.

It should be apparent that, in this manner, various exemplary embodiments enable obscuring communications network topology when messaging between Diameter applications. In particular, by altering device and realm identifiers in messages before they are transmitted outside the network.

### BRIEF DESCRIPTION OF THE DRAWINGS

In order to better understand various exemplary embodiments, reference is made to the accompanying drawings, wherein:

FIG. 1 illustrates an exemplary network environment for a Diameter Routing Agent;

FIG. 2 illustrates an exemplary embodiment of a method for configuring a Diameter Edge Agent to hide topology of a provider's network from external providers;

FIG. 3 illustrates a message diagram illustrating methods of processing Diameter messages;

FIG. 4 illustrates a message diagram illustrating methods of processing Diameter messages following FIG. 3;

FIG. 5 illustrates a message diagram illustrating methods of processing Diameter messages;

FIG. 6 illustrates an exemplary hardware diagram for a device such as a device including a DRA in a networked system.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or” refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein. Further, while various exemplary embodiments are described with regard to network topology hiding in Diameter messages, it will be understood that the techniques and arrangements described herein may be implemented to facilitate network topology hiding in other types of systems that implement multiple types of data processing or data structure.

Because no mobile telephone provider has complete coverage, in order to access the communications network, mobile service subscribers often “roam” the networks of other providers by utilizing equipment owned by providers other than those to whose service they subscribe. Providing roaming functionality to mobile customers involves communicating with the networks of other telecom providers to determine subscription access. A Diameter routing agent (DRA) in a Diameter node positioned at network boundaries may support a GSM Association (GSMA) Diameter Edge Agent (DEA), in turn supporting the creation of operator-configured routing policy rules to secure the exchange of signaling information across partner networks in a roaming infrastructure. Provider nodes may use Diameter messaging to communicate with nodes of other providers in order to achieve interoperability across networks.

In order to streamline or facilitate message routing, messages in the Diameter protocol may contain information that reveals details about the topology and configuration of the network that the messages travel over. Specifically, messages may be altered in transit to include the identity of Diameter devices through which they are routed, including the specific Origin-Host of specific devices as well as the realm organization of the network. When a request is created, the identity of the creating device may be included in the message. Additionally, the Route-Record Attribute Value Pair (AVP) in particular may provide a record or trail of the devices a message passes through as it traverses a network (e.g. the Route-Record contains a record of all of the “hops” the message passed through as it traversed the network), as each node may append its identity onto the Route-Record AVP before re-routing the message. Thus, network topology may be discovered by analyzing the Route-Record, Origin-Host, Origin-Realm, Destination-Host, Destination-Realm, or other information with network information contained in Diameter messages. This other information may vary—for example, in some situations Session-ID may include network information such as a device identity, but not in others. In some embodiments, if a session is incoming (e.g., the session originated with a roaming partner), then the roaming partner created the Session-ID for the incoming session, and it will not contain information about the internal network. But, if the session originated in the internal network, the Session-ID may be based on the device identifier of the device that originated the session. In another example, application-specific AVPs may include device, host, or realm identifiers.

When a provider interoperates with other entities such as other providers or external providers of network functions by communicating using the Diameter protocol, it may be advantageous not to reveal the details of network topology and device specifications for security and other purposes. DEAs that are positioned at network boundaries may be configured to match the details for incoming messages and to disguise these details within messages before the messages leave a provider's network.

Referring now to the drawings, in which like numerals refer to like components or steps, there are disclosed broad aspects of various exemplary embodiments.

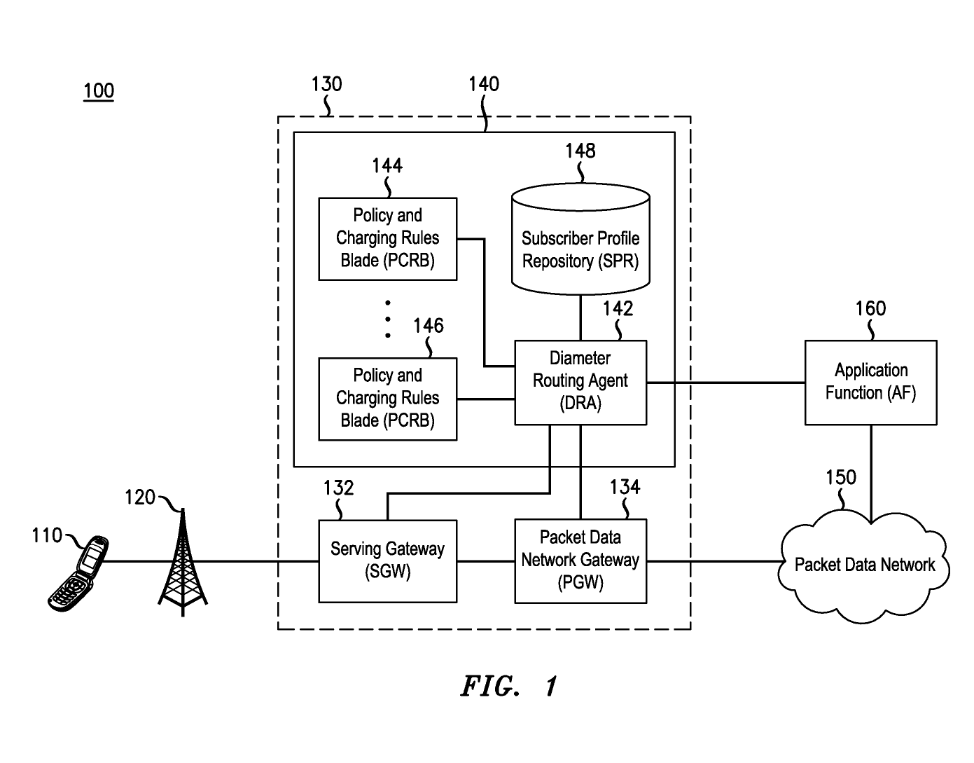

FIG. 1 illustrates an exemplary network environment 100 for a Diameter Routing Agent (DRA) 142. Exemplary network environment 100 may be a subscriber network for providing various services. In various embodiments, subscriber network 100 may be a public land mobile network (PLMN). Exemplary subscriber network 100 may be telecommunications network or other network for providing access to various services. Exemplary subscriber network 100 may include user equipment 110, base station 120, evolved packet core (EPC) 130, packet data network 150, and application function (AF) 160.

User equipment 110 may be a device that communicates with packet data network 150 for providing the end-user with a data service. Such data service may include, for example, voice communication, text messaging, multimedia streaming, and Internet access. More specifically, in various exemplary embodiments, user equipment 110 is a personal or laptop computer, wireless email device, cell phone, tablet, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by the relevant 3GPP standards. Thus, base station 120 may be a device that communicates with user equipment 110 via a first medium, such as radio waves, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various alternative embodiments, user equipment 110 may communicate directly with EPC 130. In such embodiments, base station 120 may not be present.

Evolved packet core (EPC) 130 may be a device or network of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the relevant 3GPP standards. EPC 130 may include a serving gateway (SGW) 132, a packet data network gateway (PGW) 134, and a session control device 140.

Serving gateway (SGW) 132 may be a device that provides gateway access to the EPC 130. SGW 132 may be one of the first devices within the EPC 130 that receives packets sent by user equipment 110. Various embodiments may also include a mobility management entity (MME) (not shown) that receives packets prior to SGW 132. SGW 132 may forward such packets toward PGW 134. SGW 132 may perform a number of functions such as, for example, managing mobility of user equipment 110 between multiple base stations (not shown) and enforcing particular quality of service (QoS) characteristics for each flow being served. In various implementations, such as those implementing the Proxy Mobile IP standard, SGW 132 may include a Bearer Binding and Event Reporting Function (BBERF). In various exemplary embodiments, EPC 130 may include multiple SGWs (not shown) and each SGW may communicate with multiple base stations (not shown).

Packet data network gateway (PGW) 134 may be a device that provides gateway access to packet data network 140. PGW 134 may be the final device within the EPC 130 that receives packets sent by user equipment 110 toward packet data network 140 via SGW 132. PGW 134 may include a policy and charging enforcement function (PCEF) that enforces policy and charging control (PCC) rules for each service data flow (SDF). Therefore, PGW 134 may be a policy and charging enforcement node (PCEN). PGW 134 may include a number of additional features such as, for example, packet filtering, deep packet inspection, and subscriber charging support. PGW 134 may also be responsible for requesting resource allocation for unknown application services.

Session control device 140 may be a device that provides various management or other functions within the EPC 130. For example, session control device 140 may provide a Policy and Charging Rules Function (PCRF). In various embodiments, session control device 140 may include an Alcatel Lucent 5780 Dynamic Services Controller (DSC). Session control device 140 may include a DRA 142, a plurality of policy and charging rules blades (PCRBs) 144, 146, and a subscriber profile repository.

DRA 142 may be an intelligent Diameter Routing Agent. As such, DRA 142 may receive, process, and transmit various Diameter messages. DRA 142 may include a number of user-defined rules that govern the behavior of DRA 142 with regard to the various Diameter messages DRA 142 may encounter. Based on such rules, the DRA 142 may operate as a relay agent, proxy agent, or redirect agent. A DEA may be resident on DRA 142. For example, DRA 142 may relay received messages to an appropriate recipient device. Such routing may be performed with respect to incoming and outgoing messages, as well as messages that are internal to the session control device.

Policy and charging rules blades (PCRB) 144, 146 may each be a device or group of devices that receives requests for application services, generates PCC rules, and provides PCC rules to the PGW 134 or other PCENs (not shown). PCRBs 144, 146 may be in communication with AF 160 via an Rx interface. As described in further detail below with respect to AF 160, PCRB 144, 146 may receive an application request in the form of an Authentication and Authorization Request (AAR) from AF 160. Upon receipt of an AAR, PCRB 144, 146 may generate at least one new PCC rule for fulfilling the application request.

PCRB 144, 146 may also be in communication with SGW 132 and PGW 134 via a Gxx and a Gx interface, respectively. PCRB 144, 146 may receive an application request in the form of a credit control request (CCR) from SGW 132 or PGW 134. As with an AAR, upon receipt of a CCR, PCRB 144, 146 may generate at least one new PCC rule for fulfilling the application request. In various embodiments, the AAR and the CCR may represent two independent application requests to be processed separately, while in other embodiments, the AAR and the CCR may carry information regarding a single application request and PCRB 144, 146 may create at least one PCC rule based on the combination of the AAR and the CCR. In various embodiments, PCRB 144, 146 may be capable of handling both single-message and paired-message application requests.

Upon creating a new PCC rule or upon request by the PGW 134, PCRB 144, 146 may provide a PCC rule to PGW 134 via the Gx interface. In various embodiments, such as those implementing the proxy mobile IP (PMIP) standard for example, PCRB 144, 146 may also generate QoS rules. Upon creating a new QoS rule or upon request by the SGW 132, PCRB 144, 146 may provide a QoS rule to SGW 132 via the Gxx interface.

Subscriber profile repository (SPR) 148 may be a device that stores information related to subscribers to the subscriber network 100. Thus, SPR 148 may include a machine-readable storage medium such as read-only memory (ROM), random-access memory (RAM), magnetic disk storage media, optical storage media, flash-memory devices, and/or similar storage media. SPR 148 may be a component of one of PCRB 144, 146 or may constitute an independent node within EPC 130 or session control device 140. Data stored by SPR 148 may include subscriber information such as identifiers for each subscriber, bandwidth limits, charging parameters, and subscriber priority.

Packet data network 150 may be any network for providing data communications between user equipment 110 and other devices connected to packet data network 150, such as AF 160. Packet data network 150 may further provide, for example, phone or Internet service to various user devices in communication with packet data network 150.

Application function (AF) 160 may be a device that provides a known application service to user equipment 110. Thus, AF 160 may be a server or other device that provides, for example, a video streaming or voice communication service to user equipment 110. AF 160 may further be in communication with the PCRB 144, 146 of the EPC 130 via an Rx interface. When AF 160 is to begin providing known application service to user equipment 110, AF 160 may generate an application request message, such as an authentication and authorization request (AAR) according to the Diameter protocol, to notify the PCRB 144, 146 that resources should be allocated for the application service. This application request message may include information such as an identification of the subscriber using the application service, an IP address of the subscriber, an APN for an associated IP-CAN session, or an identification of the particular service data flows that must be established in order to provide the requested service.

As will be understood, various Diameter applications may be established within subscriber network 100 and supported by DRA 142. For example, an Rx application may be established between AF 160 and each of PCRBs 144, 146. As another example, an Sp application may be established between SPR 148 and each of PCRBs 144, 146. As yet another example, an S9 application may be established between one or more of PCRBs 144, 146 and a remote device implementing another PCRF (not shown). As will be understood, numerous other Diameter applications may be established within subscriber network 100.

In supporting the various potential Diameter applications, DRA 142 may receive Diameter messages, process the messages, and perform actions based on the processing. For example, DRA 142 may receive a Gx CCR from PGW 134, identify an appropriate PCRB 144, 146 to process the Gx CCR, and forward the Gx CCR to the identified PCRB 144, 146. DRA 142 may also act as a proxy by modifying the subsequent Gx CCA sent by the PCRB 144, 146 to carry an origin-host identification pointing to the DRA 142 instead of the PCRB 144, 146. Additionally or alternatively, DRA 142 may act as a redirect agent or otherwise respond directly to a request message by forming an appropriate answer message and transmitting the answer message to an appropriate requesting device.

In some deployments, a DRA such as DRA 142 may be configured as an “edge agent,” a Diameter device on the edge of a provider's Diameter network that acts as a gateway for Diameter messages going to and from the networks of roaming partners. A Diameter edge agent (DEA) may process messages incoming to the provider's network and outgoing from the provider's network in order to hide the details of the local network from roaming partners. Topology hiding may be carried out while preserving efficient routing by obfuscating specific details of the local network but maintaining a one-to-one mapping between the true identities of Diameter devices in the local network and an alternate identity presented to roaming partners. Such an approach may be efficient in that it may require few computational resources to match true identities with alternate identities. For example, translation of true identities into alternate identities may be based on regular expressions, simple calculations which require comparatively few resources.

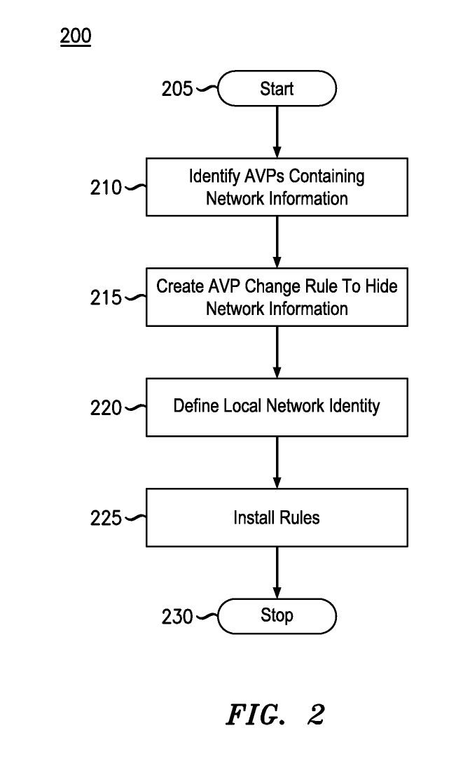

FIG. 2 illustrates an exemplary embodiment of a method for configuring a DEA to hide topology of a provider's network from external providers such as roaming partners. The method 200 may begin at step 205 and at step 210 specific AVPs that may leak topology details may be identified. For example, a list of identifying information may be provided, for example through a user interface or configuration file, and the list may be compared to rules that populate AVPs to determine if the identifying information is used to populate the AVPs. All AVPs that may leak topology details may be identified. In some embodiments, the AVPs may be listed with the message types for which they may leak topology details. For example, the same AVP may leak topology details if it is included in one type of message, but not if it is included in another type of message. In another example, messages may leak topology details only in one direction, as described above.

At step 215 patterns may be stored for hiding the true device identities. For example, each device or device identifier may be provided with a unique identifier that does not include actual device name or realm information. In some embodiments, devices may be provided with a sequential numeric identifier. In some embodiments, a pool or pools of random fictitious unique device identifiers may be generated and randomly assigned to devices in the network. In some embodiments, a user, for example, a network administrator, may specify through an interface, such as a graphical user interface (GUI) or a configuration file or provision through an API, patterns to identify identifiers and/or to accomplish hiding of identifiers. For example, a user may configure what portions of a named AVP relate to identity so that internal or external devices may be determined, and if internal, those portions of the AVP relating to device identity may be transformed and saved over as hidden identities as described below. Configuration information may include, for example, an AVP name, a regular expression, and a replacement string or expression.

At step 220 a local network identity may be defined in order that a DEA may distinguish between nodes in the provider's local network and nodes external to the provider's network. As known in the art, local network identity may rely at least partly on Diameter realms—some network operators may have multiple realms that may be included in the local network identity, for example, a provider such as Verizon may aggregate bellatlantic.com and gte.com in their internal primary domain verizon.com. Thus, so that the DEAs may determine which devices are included in the local network, and whether incoming messages are from network subscribers, in step 220 all Origin-Hosts included in the local realm (i.e. are associated with the provider's internal network) may be included as a local network identity. The home network identity may be defined and managed as described in U.S. patent application Ser. No. 12/257,762, filed Oct. 18, 2011, entitled “PCRN HOME NETWORK IDENTITY” which is incorporated by reference herein for all purposes.

At step 225 rules may be installed so that the DEA evaluates each message as it is sent between external and internal nodes to hide or restore topology information as described below. At step 230, the method may end.

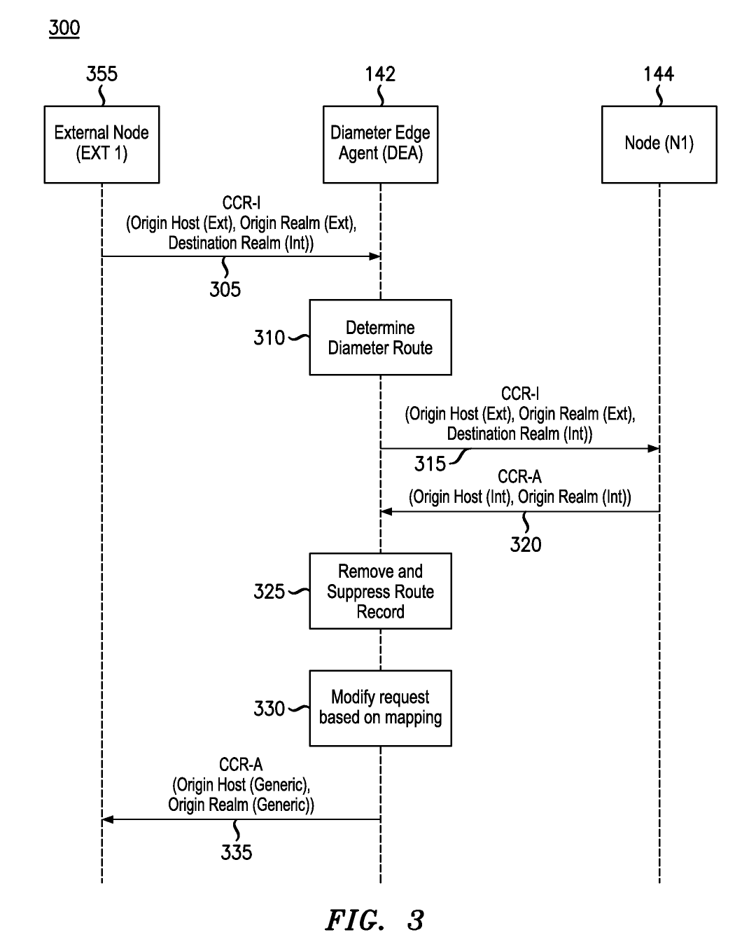

FIG. 3 illustrates a message diagram 300 illustrating methods of processing Diameter messages. An arrow in FIG. 3 may illustrate a message sent from one network node to another network node. Accordingly, an arrow may represent both a step of sending the message and a step of receiving the message. As noted above, a Diameter message may include a plurality of fields or AVPs. Various fields of the Diameter message may be required by a Diameter application while other fields may be optional.

As will be discussed, there are four cases where a message may cross a DEA and where it may be determined what information, if any, should be altered in AVPs in order to hide network topology: the message may be 1) a request or an answer, and 2) may be transmitted from an internal node to an external node, or from an external node to an internal node. The direction of the message, e.g., whether the message originated internally or externally, and whether it is destined for a device that is internal or external, may be determined based on the Origin-Host and Origin-Realm and the Destination-Host and Destination-Realm values of the message, if they are included, as well as the internal network identity defined as discussed above. Although Diameter response messages may not include destination values, the values will be implied based upon the original request message, because through normal operations a node may reference the request message to determine the original destination (and thus derive the direction of travel).

The DEA might determine where the message originated because it may affect whether fields contain information related to internal topology. For example, in the case where a session is incoming (i.e., it originated with a roaming partner), then the roaming partner will have created the Session-ID, and the Session-ID will not contain information about the internal network, and thus will not be processed to remove network information. But in the case where the session originated in the network, the Session-ID may contain network information, and thus the Session-ID may be processed to hide the origin of the Session-ID.

Note that for messages passed using some communications protocols, such as S9, roaming will be symmetric such that for an S9 message, half the Session-IDs will be created in the network (and thus contain network information), and half of the Session-IDs will be created externally (and thus not create internal network information). Therefore, in cases where the origin of a message is unclear, the value of the Session-ID field may be analyzed to determine whether the identity is related to the internal network or not; if so, the hiding algorithm may be run. In some AVPs the network origin may be more obvious—for example, if the Origin-Host AVP is included, network origin is simple to determine because the content of the AVP will indicate which direction the request is going. Not all content related to network details will be hidden. For example, IP addresses may not be addressed by the topology hiding algorithm, because IP addresses do not leak any information—for external addresses IP addresses are allocated by a public or semi-public source, and thus would be externally available even if they were hidden, and for internal (e.g. NAT'ed) addresses the IP addresses may be arbitrary and/or may be allocated uniquely per session.

In step 305, an external Diameter node 355 may send a session initiation message to DRA 142. For example, the session initiation message may be a CCR initial message. The session initiation message may include required fields such as a Session-ID and an Origin-Host and Origin-Realm identifying the external diameter client 355. The session initiation message may also include a Destination-Realm identifying the realm of an internal host such as PCRB 144. As discussed above, the session initiation message may incorrectly identify the actual Destination-Realm and further may not include a Destination-Host identifying host 144. The session initiation message may further include optional content fields such as a subscriber-ID.

In step 310, the DEA resident on DRA 142 may determine a Diameter route for the session initiation message. In step 315, the DEA resident on DRA 142 may forward the session initiation request message to a host 144 based on the determined Diameter routing. In various embodiments, the DEA resident on DRA 142 may forward the session initiation request message as received. In various alternative embodiments, the DEA resident on DRA 142 may modify the session initiation request message. For example, the DEA resident on DRA 142 may update a Destination-Realm based on the determined Diameter routing or add a Destination-Host to the session initiation request message.

For incoming initial requests, no topology hiding may be performed because no internal network information will be sent to an external node. In step 320, host 144 may send a response to the session initiation request message. The response may be, for example, a CCA message. The response may include an Origin-Host and Origin-Realm describing the host 144. The response may also include content regarding the Diameter session.

In step 325, the DEA resident on DRA 142 may detect that the message is being sent from an internal node to an external node based on one or more elements of the message such as the Origin-Host, Origin-Realm, Destination-Host, or Destination-Realm as discussed above, and may remove the route record AVP from the message and instruct itself to not add to/create the Route-Record AVP when it routes the message to the external node. In step 330 the DEA resident on DRA 142 may modify the response message as follows. The Origin-Host value may be extracted and replaced with a generic name identifier generated by a regular expression or other pattern. The Origin-Realm value may be extracted and either replaced with the network provider's primary realm, left blank, or changed to the realm to which the initial request was sent (if not the primary realm). The extracted and replaced Origin-Host and Origin-Realm may be more accurate or more specific than the Diameter identity based on the session initiation request. For example, the Origin-Host and Origin-Realm may indicate host 144 and the specific realm of host 144 that may otherwise be subsumed in the network provider's local or primary domain. As another example, the Origin-Host may identify a specific host 144, whereas the Destination-Realm of the session initiation request included only a Destination-Realm.

In step 335, the DRA 142 may forward the modified message to the external node 355. In some embodiments, the DEA resident on DRA 142 may create an entry in Diameter mapping for the requested session based on the session initiation request and the response. The entry may include the Session-ID field, Diameter Origin-Realm field, origin host field, modified Origin-Realm, and modified Origin-Host.

Note that for responses to other types of requests from external nodes, in particular, answer messages sent from an internal node to an external node in response to a request sent by the external node, steps 320 through 335 will be essentially the same—the route-record AVP may be deleted and additions to it suppressed, the identities of nodes are disguised by modifying AVPs using configured regular expression and replacement string pairs, and the message may be sent to external nodes using modified AVPs. Although FIG. 3 illustrates an initial request, the answer process may be common for any internal-to-external response, e.g. from internal node N1 144 through the edge agent DEA 142 to an external network location such as 355, the identity of the server serving the request may be hidden.

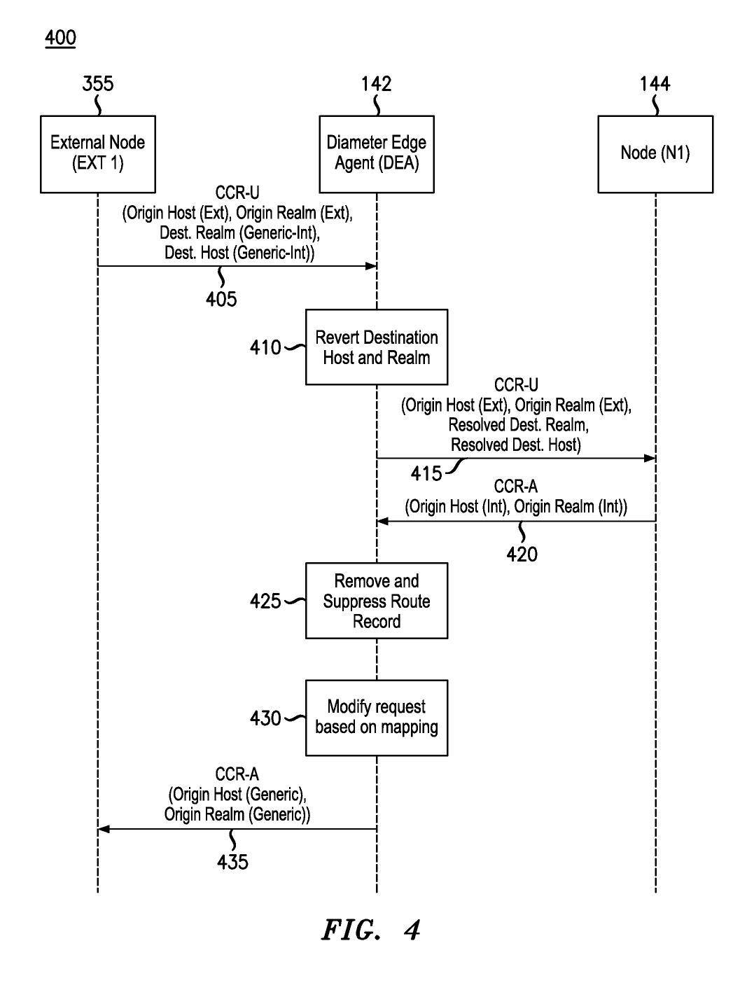

FIG. 4 illustrates a message diagram 400 illustrating methods of processing Diameter messages following FIG. 3. For subsequent requests from the external network to the internal network, in step 405 the external diameter node 355 may send a message to DRA 142. For example, the subsequent request message may be a CCR update request message. The subsequent request message may include required fields such as an Origin-Host and Origin-Realm identifying the external diameter client 355 and may also include a Destination-Realm and further may include a Destination-Host where the Destination-Host and Realm may contain the modified/generic values sent by the DEA resident on DRA 142 in response to the initial messages. At step 410, the DEA resident on DRA 142 may detect that the message is being routed from an external node to an internal node based on one or more elements of the message such as the Origin-Host, Origin-Realm, Destination-Host, or Destination-Realm, for example the Origin-Host may not be part of the internal network, and/or the destination may be a genuine internal network identity or an adapted or generic internal identity. When the modified identity of the internal node is used, the DEA resident on DRA 142 may revert the incoming values of the Destination-Host, Destination-Realm, and possibly other values, for example, identifiers such as the Session-ID, back to their original values based on mapping or string expressions. Some values may not be transformed based upon a determination of whether the information contained within them contains information that should be transformed. For example, the transformation of Session-ID may be conditional on a determination of whether the Session-ID in each message contains a value that would indicate a local network identity. This determination, as described above, may be based upon a simple pattern match (which would save time relative to a full transformation and over-write). Once the modified values are reverted to the original values 410, in step 415 the message may be routed to the correct internal node 144.

As noted above with respect to FIG. 3, the answer process may be common for any internal-to-external response, e.g. from internal node N1 144 through the edge agent DEA 142 to an external network location such as 355, so that the identity of the server serving the request may be hidden. The steps performed for responses to requests from external nodes, in particular, answer messages sent from an internal node to an external node in response to a request sent by the external node, will be essentially the same—the route-record AVP may be deleted, the identities of nodes are disguised by modifying AVPs using configured regular expression and replacement string pairs, and the message may be sent to external nodes using modified AVPs. Thus, in step 420, host 144 may send a response to the subsequent request message. The response may be, for example, a CCA message. The response may include an Origin-Host and Origin-Realm describing the host 144. The response to the subsequent request message may also include content regarding the Diameter session. In step 425, the DEA resident on DRA 142 may detect that the message is being sent from an internal node to an external node based on one or more elements of the message such as the Origin-Host, Origin-Realm, Destination-Host, or Destination-Realm as discussed above, and may remove the Route-Record AVP from the message. In step 430 the DEA resident on DRA 142 may modify the response message by extracting the Origin-Host value and replacing it with the generic name identifier as mapped and stored, or as generated by a regular expression or other pattern. Further, the diameter stack may be sent an instruction not to add to the Route-Record, but rather use the mapped identity to track the route. This is to suppress the diameter stack from, before forwarding the message, adding the identity of the origin onto the message's Route-Record.

In step 435, the DRA 142 may forward the modified message to the external node 355. In some embodiments, the DEA resident on DRA 142 may create an entry in Diameter mapping for the requested session based on the session initiation request and the response. The entry may include the Session-ID field, Diameter Origin-Realm field, Origin-Host field, modified Origin-Realm, and modified Origin-Host.

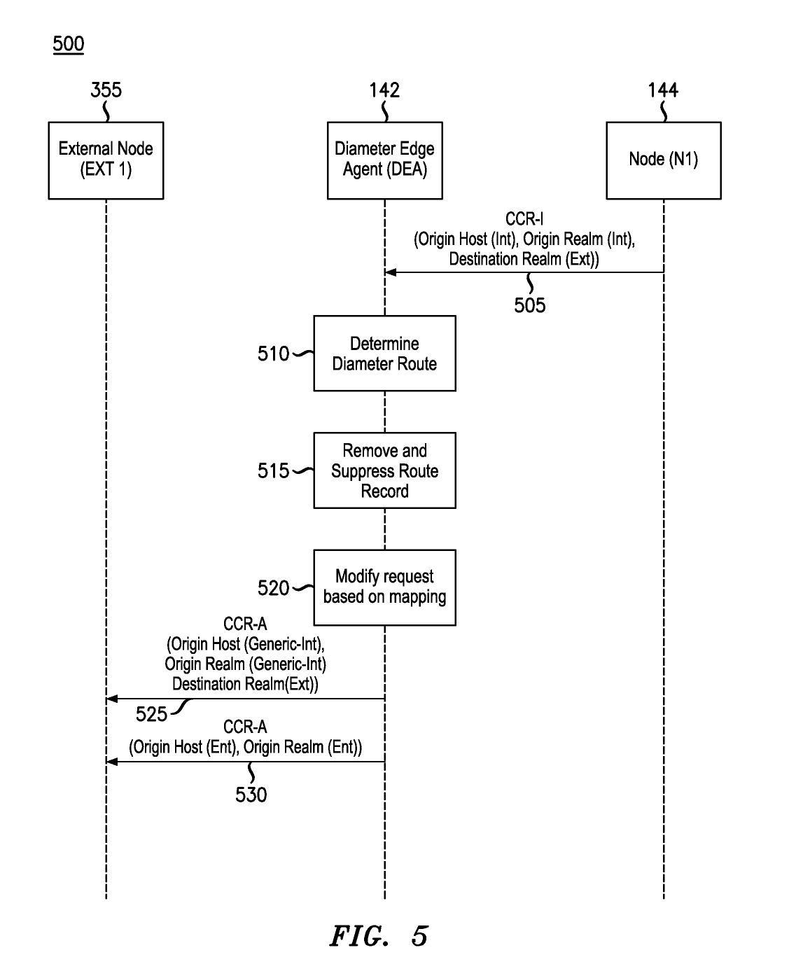

FIG. 5 illustrates a message diagram 500 illustrating methods of processing Diameter messages. For requests from the internal network to the external network, the route-record AVP may be removed by the DEA resident on DRA 142 before the request is sent from an internal node to an external node. The remaining AVPs may be modified if the regular expression and replacement string pair or other modification rule are configured for the AVP.

In step 505, an internal diameter node 144 may send a session initiation message to DRA 142. For example, the session initiation message may be a CCR initial message. The session initiation message may include required fields such as a Session-ID and an Origin-Host and Origin-Realm identifying the internal diameter node 144. The Origin-Host and Origin-Realm may be the actual identity of the node device 144. The session initiation message may also include a Destination-Realm identifying the realm of an external host 355.

At step 510 the DEA resident on DRA 142 may detect that the message is a CCR-I, determine based on the Origin-Realm and Destination-Realm values that the origin is the internal network and the destination is not, and therefore this is an internal to external case. At step 515 the DEA resident on DRA 142 may remove the Route-Record AVP from the message and suppress it at the diameter stack as described above. In step 520 the DEA resident on DRA 142 may modify the response message as follows. The Origin-Host value may be extracted and replaced with a generic name identifier generated by a regular expression or other pattern. The Origin-Realm value may be extracted and either replaced with the network provider's primary realm, left blank, or changed to the realm to which the initial request was sent (if not the primary realm). Other AVPs may be altered if they were so configured with rules as described above. Note that if this is the first time the device identity (Origin-Host, Origin-Realm) has been mapped to the mapped/generic identity, then in some embodiments the mapping of the device identity to the mapped identity may be stored in the internal cache of mappings of device identities to mapped identities (so that the information is later available for key lookups).

At step 525, once the Origin-Host and Origin-Realm, and any other indicated values have been altered to the mapped or patterned values, the message may be forwarded on to the external network. Note the Destination-Realm may not be altered but instead passed though as whatever the Destination-Realm is in the external (destination) network. Further note that for an answer coming back from an external network to the internal network as in step 530, the DEA resident on DRA 142 may operate normally, because if the Destination-Realm 355 sends a response/answer/CCA), with the message originating from the external realm, no Destination-Realm information will be included in the answer. Rather, the request may be analyzed to determine whether it was internal to external—because in this case the request associated with the answer was internal-to-external, therefore this answer is from an external node returning to an internal node, nothing needs to be done, because the CCA returns to the originating node automatically as part of the Diameter protocol by matching information with the request message. As such, the identity information contained in the message will be irrelevant for topology hiding because answer messages will likely have no destination information. In an answer message the destination will be implicit, the answer will return to where the request originated from; the diameter stack has the capability to return the answer to its upstream origin.

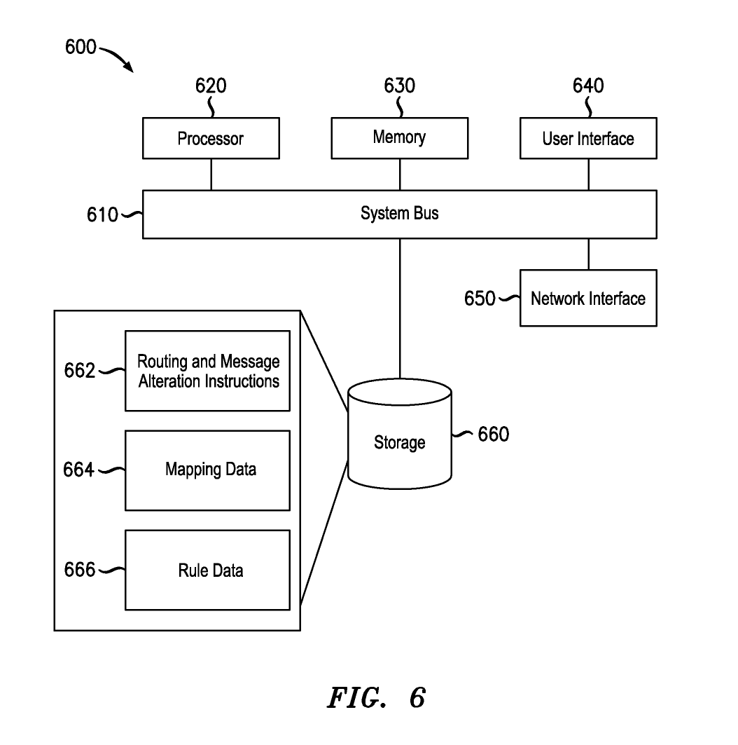

FIG. 6 illustrates an exemplary hardware diagram for a device 600 such as a device including a DRA in a networked system. The exemplary device 600 may correspond to the DRA 142 of FIG. 1. As shown, the device 600 includes a processor 620, memory 630, user interface 640, network interface 650, and storage 660 interconnected via one or more system buses 610. It will be understood that FIG. 6 constitutes, in some respects, an abstraction and that the actual organization of the components of the device 600 may be more complex than illustrated.

The processor 620 may be any hardware device capable of executing instructions stored in memory 630 or storage 660. As such, the processor may include a microprocessor, field programmable gate array (FPGA), application-specific integrated circuit (ASIC), or other similar devices.

The memory 630 may include various memories such as, for example L1, L2, or L3 cache or system memory. As such, the memory 630 may include static random access memory (SRAM), dynamic RAM (DRAM), flash memory, read only memory (ROM), or other similar memory devices.

The user interface 640 may include one or more devices for enabling communication with a user such as an administrator. For example, the user interface 640 may include a display, a mouse, and a keyboard for receiving user commands.

The network interface 650 may include one or more devices for enabling communication with other hardware devices. For example, the network interface 650 may include a network interface card (NIC) configured to communicate according to the Ethernet protocol. Additionally, the network interface 650 may implement a TCP/IP stack for communication according to the TCP/IP protocols. Various alternative or additional hardware or configurations for the network interface 650 will be apparent.

The storage 660 may include one or more machine-readable storage media such as read-only memory (ROM), random-access memory (RAM), magnetic disk storage media, optical storage media, flash-memory devices, or similar storage media. In various embodiments, the storage 660 may store instructions for execution by the processor 620 or data upon with the processor 620 may operate. For example, the storage 660 may store routing and message alteration instructions 662 for performing network topology hiding according to the concepts described herein. The storage may also store Mapping Data 664 and Rule Data 666 for use by the processor executing the routing and message alteration instructions 662.

According to the foregoing, various exemplary embodiments provide for network topology hiding. In particular, by detecting communications between external and internal nodes and altering the network-identifying information within messages sent from internal nodes to external nodes.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A network device configured to hide network topological information, the network device comprising:
a network interface configured to communicate with other devices in a network;
a memory; and
a processor in communication with the network interface and the memory, the processor configured to:
receive a message;
identify in the message one or more Attribute Value Pairs (AVPs) with network information;
define a local network identity;
and evaluate a plurality of messages to determine whether one of a source of the message and a destination of the message are included in the local network identity.

2. The device of claim 1, wherein the processor is further configured to:
when identifying one or more AVPs, search a regular expression; and
generate one or more patterns to modify the one or more AVPs;

3. The device of claim 1, wherein the processor is further configured to, when identifying one or more AVPs, identify a message type of each of the one or more AVPs.

4. The device of claim 1, wherein the processor is further configured to, when identifying one or more AVPs, identify a portion of one or more of the AVPs, wherein the portion contains network topological information.

5. A non-transitory machine-readable storage medium encoded with instructions for execution by a Diameter Routing Agent (DRA) for hiding network topological information in a Diameter message, the medium comprising:
instructions for receiving a Diameter message;
instructions for determining a Origin-Host and a Destination-Realm based on the Diameter message;
instructions for determining at least one of the Origin-Host and the Destination-Realm is external to a local network identity, and at least another one of the Origin-Host and the Destination-Realm is internal to the local network identity;
instructions for removing a Route-Record AVP from the Diameter message; and
instructions for suppressing additions to the Route-Record AVP.

6. The medium of claim 5, wherein the message comprises one or more of an Origin-Host value, an Origin-Realm value, a Destination-Host value, and a Destination-Realm value.

7. The medium of claim 6, wherein the instructions for determining at least one of the Origin-Host and the Destination-Realm is external to the local network identity and at least another one of the Origin-Host and the Destination-Realm is internal to the local network identity comprise instructions for evaluating one or more of the Origin-Host value, the Origin-Realm value, the Destination-Host value, and the Destination-Realm value.

8. The medium of claim 5, wherein the message comprises one or more of an Origin-Host value and an Origin-Realm value.

9. The medium of claim 8, wherein the instructions for determining at least one of the Origin-Host and the Destination-Realm is external to the local network identity and at least another one of the Origin-Host and the Destination-Realm is internal to the local network identity comprise
instructions for determining one or more of the Destination-Host and the Destination-Realm based upon the Origin-Host value and the Origin-Realm value; and
instructions for determining one or more of the Origin-Host and the Origin-Realm based upon the Origin-Host value and the Origin-Realm value.

10. The medium of claim 5, further comprising instructions for routing the Diameter message to the Destination-Realm.

11. The medium of claim 5, further comprising instructions for modifying an Origin-Realm.

12. The method of claim 11, further comprising instructions for forwarding the modified message to a Destination-Host.

13. The medium of claim 5, further comprising instructions for modifying an Origin-Host.

14. The method of claim 13, further comprising instructions for forwarding the modified message to a Destination-Host.

15. The medium of claim 5, further comprising instructions for modifying a Session-ID AVP.

16. The medium of claim 5, further comprising instructions for modifying a portion of a Session-ID AVP.

17. A non-transitory machine-readable storage medium encoded with instructions for execution by a Diameter Routing Agent (DRA) for processing a Diameter message, the medium comprising:
instructions for identifying one or more Attribute Value Pairs (AVPs) with network information;
instructions for generating one or more patterns to modify the one or more AVPs;
instructions for defining a local network identity;
and instructions for evaluating a plurality of messages to determine whether one of a source of the message and a destination of the message are included in the local network identity.

18. The medium of claim 17, wherein the instructions for identifying one or more AVPs further comprises instructions for searching using a regular expression.

19. The medium of claim 17, wherein the instructions for identifying one or more AVPs further comprises instructions for identifying a message type of each of the one or more AVPs.

20. The medium of claim 17, wherein the instructions for identifying one or more AVPs further comprises instructions for identifying a portion of one or more of the AVPs, wherein the portion contains network topological information.
